(19) United States
(12) Patent Application Publication
(10) Pub. No.: US 2006/0271587 A1
(43) Pub. Date: Nov. 30, 2006

(54) Apparatus for displaying a data storage medium content directory of a data storage medium

(75) Inventor: Bernd Weymann, Braunfels (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft, Munchen (DE)

(21) Appl. No.: 11/435,617

(22) Filed: May 17, 2006

(30) Foreign Application Priority Data
May 18, 2005 (DE) 10 2005 022 871.2

(51) Int. Cl. G06F 7/00

(52) U.S. Cl. 707/102

(57) ABSTRACT

An apparatus comprises an input device, a display unit and a memory. The input device receives a user request for selecting a current position in a data storage medium content directory. The display unit displays data entries in the data storage medium content directory in the form of at least one first list based on the current position in the data storage medium content directory. The memory includes at least one second list containing data entries. The second list comprises all entries of the first list. The apparatus reads at least one further data entry in the data storage medium content directory from the data storage medium and stores it in the second list, and replaces at least one data entry stored in the second list with the at least one further data entry.

### BACKGROUND OF THE INVENTION

1. Field of the Invention

The invention relates to an apparatus for displaying a data storage medium content directory of a data storage medium, the apparatus comprising a display unit which displays data entries of the data storage medium content directory in the form of at least one list on the basis of a current position in the data storage medium content directory.

2. Description of the Related Art

Data storage media, such as compact discs, digital versatile discs or hard disks, are increasingly available with larger storage capacities. This means that the data storage medium is able to store a large number of directories or files. To find a required file, a data storage medium content directory needs to be loaded from the data storage medium. The data storage medium content directory on such a data storage medium may require a large amount of memory. Apparatuses which access such a data storage medium may not have sufficient memory, however, to be able to load the data storage medium content directory without restrictions and navigate through it. For this reason, restrictions are provided which limit the depth of directory structures on the data storage medium or the length of file names or directory names, for example. If appropriate, file names or directory names are replaced with numbers in order to reduce the memory requirement for the data storage medium content directory. This makes it more difficult to navigate through extensive data storage medium content directories.

### SUMMARY OF THE INVENTION

An object of the invention is to provide an apparatus for displaying a data storage medium content directory for a data storage medium in which the data storage medium content directory on the data storage medium can be displayed reliably.

According to the invention, the apparatus comprises an input device, a display unit and a memory. The input device serves to receive a user request defining a current position in the data storage medium content directory. The display unit displays a first maximum number of successive data entries in the data storage content directory in the form of at least one first list on the basis of the current position in the data storage medium content directory. The memory stores at least one second list containing a second maximum number of data entries. The second maximum number of data entries is at least as great as the first maximum number of data entries. The at least one second list comprises all entries of the at least one first list. The apparatus further comprises means for reading at least one further data entry in the data storage medium content directory from the data storage medium on the basis of the current position and for storing the further data entry in the at least one second list if this further data entry is currently not stored in the at least one second list. The apparatus further comprises means for replacing at least one data entry stored in the at least one second list with the at least one further data entry if the at least one second list already comprises the second maximum number of data entries.

The advantage is that a limitation of memory space in the memory is defined by the second maximum number of data entries in the at least one second list. This memory space is also independent of a storage capacity of the data storage medium or of the number of data entries in the data storage medium content directory. Data entries in the data storage medium content directory represent a directory, a directory path or a file, for example.

By way of example, the apparatus is a music, video or picture reproduction apparatus which can be supplied with data storage media having a large storage capacity, e.g. CDs, DVDs, flash storage media or hard disks. Display and navigation in extensive data storage medium content directories on such data storage media is possible reliably.

If the second maximum number of data entries is greater than the first maximum number of data entries, this allows navigation in the data storage medium content directory to be speeded up, since it is not necessary to read the at least one further data entry from the data storage medium each time the current position in the data storage medium content directory is altered. By way of example, data entries which are arranged in the data storage medium content directory directly before or after data entries which are associated with the at least one first list are stored in the at least one second list so as to allow rapid access to these data entries when the current position is altered due to a user request.

In one advantageous embodiment of the apparatus, the user request received by the input device defines the current position as a selected data entry which represents a directory or a directory path. The current position can also be selected by moving the current position in the data storage medium content directory forward or backward in steps of at least one data entry. The advantage is that navigation through the data storage medium content directory is thus a very simple matter. In addition, it is easy to navigate to any possible position in the data storage medium content directory.

In another advantageous embodiment of the apparatus, at least two second lists of data entries of the data storage medium content directory are provided in the memory. The apparatus associates the at least one further data entry with one of the at least two second lists on the basis of a data entry type. In this connection, the data entry type means that the relevant data entry represents a directory, a file or a directory path, for example. The advantage is that directories, files or directory paths can, thus be stored in separate second lists. On the basis of the current position in the data storage medium content directory, the at least one first list may be associated with one of the at least two second lists. Navigating through the data storage medium content directory may in this way be a particularly clear and simple matter.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a block diagram which shows an apparatus for displaying a data storage medium content directory of a data storage medium,

FIG. 2 is a block diagram which shows an example of a data storage medium content directory of a first list and of a second list,

FIG. 3 is a first flowchart of a first program executed in the apparatus, and

FIG. 4 is a second flowchart of a second program executed in the apparatus.

### DETAILED DESCRIPTION OF THE PRESENTLY PREFERRED EMBODIMENTS

Elements of identical design or function have been provided with the same reference symbols throughout the figures.

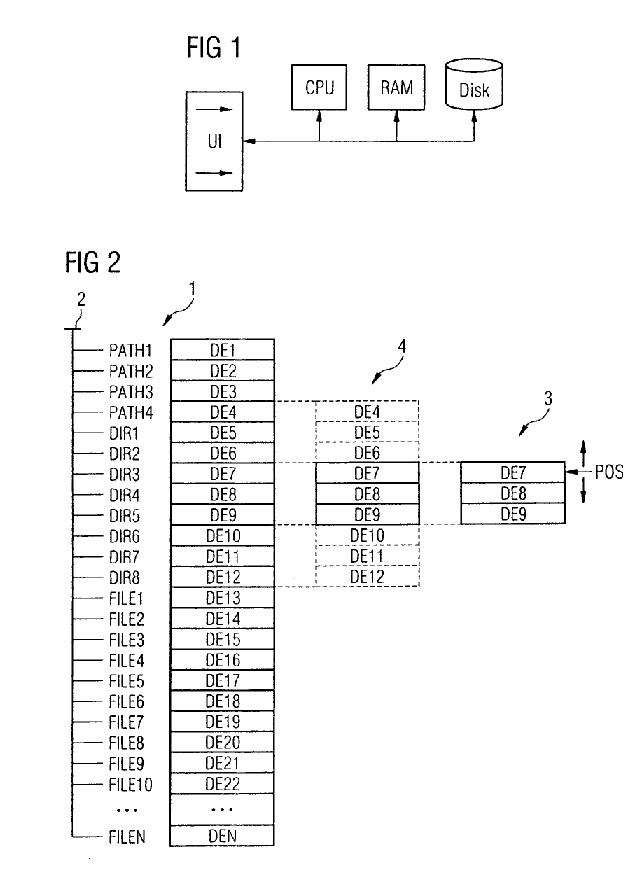

FIG. 1 shows an apparatus which comprises a processor CPU, a memory RAM and a user interface UI. By way of example, the user interface UI has input elements for controlling the apparatus. The user interface UI also comprises a display unit.

The apparatus comprises a data storage medium DISK or can be coupled to the data storage medium DISK. By way of example, the data storage medium DISK is a drive for compact discs or digital versatile discs. However, the data storage medium DISK may also be a hard disk or a flash storage medium or another data storage medium, for example. The apparatus may also comprise more than one data storage medium DISK or may be coupled to more than one data storage medium DISK. A storage capacity for the data storage medium DISK, particularly if it is the digital versatile disc, the hard disk or the flash storage medium, may be between several gigabytes and several hundred gigabytes. Such data storage media DISK are able to store a large number of files FILE, e.g. music files or picture files, particularly in compressed formats, such as “MP3” or “JPG”. A data storage medium content directory 1 representing these files FILE in organized form (FIG. 2) may be of similar extent. The files FILE may also be organized in directories DIR, whereby a tree-like structure for the data storage medium content directory 1 can be produced. A current directory 2 is a root directory for the data storage medium content directory 1 or a directory DIR within the data storage medium content directory 1, for example, which in turn may comprise files FILE, directories DIR or directory paths PATH. The directory path PATH is an organized list of directories DIR which unambiguously represents a respective position of a file FILE in the data storage medium content directory 1. The current directory 2 may store several thousands or ten thousands of files FILE or directories DIR but may also store fewer files FILE or directories DIR.

The display unit of the user interface UI is designed to display at least one first list 3 of data entries DE in the data storage medium content directory 1. A data entry DE is associated with a file FILE, with a directory DIR or with a directory path PATH, for example, and comprises a file name, a directory name or the directory path PATH. Preferably, the file name, the directory name or the directory path PATH are displayed on the display unit. The at least one first list 3 covers only a first maximum number of data entries DE, e.g. three data entries DE, on account of the display unit being of limited size. There may also be more than one first list 3 provided. By way of example, directories DIR, directory paths PATH or files FILE may be able to be displayed in separate first lists 3. Similarly, there may additionally be provided a further first list 3 in which the available data storage media DISK can be displayed. The available data storage media, the directory paths PATH, the directories DIR or the files FILE may also be covered by a single first list 3, however.

Generally, a number of data entries DE in the data storage medium content directory 1 may be very much greater than the first maximum number of data entries DE which can be displayed on the display unit, so that the at least one first list 3 of data entries can comprise only a partial section of the data storage medium content directory 1. The apparatus is therefore designed to allow navigation through the data storage medium content directory 1 by moving this section. To this end, the memory RAM stores at least one second list 4 which covers a second maximum number of data entries DE in the data storage medium content directory 1. The second maximum number of data entries DE is at least as great as the first maximum number of data entries DE. The at least one first list 3 of data entries DE is part of the at least one second list 4 of data entries DE, each first list 3 preferably having a respective associated second list 4.

Upon a user request, it is possible to select a current position POS in the data storage medium content directory 1, e.g. by using the input elements of the user interface UI. On the basis of the current position POS, data entries DE in the data storage medium content directory 1 are read from the data storage medium DISK and are stored in the at least one second list 4. The at least one first list 3 may be updated correspondingly based on the current position.

By way of example, the user request is a forward or backward movement of the current position POS in the data storage medium content directory 1. However, the user request may also be selection of a directory DIR, for example. The effect of selecting the directory DIR is that the selected directory DIR becomes the current directory 2. A content in the current directory 2, e.g. not exceeding the second maximum number of data entries DE, is then read from the data storage medium DISK and is stored in the at least one second list 4. The at least one first list 3 is updated correspondingly, so that the content of the current directory 2 is displayed on the display unit based on the current position.

The at least one second list 4 of data entries DE can store no more than the second maximum number of data entries DE. If the second maximum number of data entries DE is already stored in the at least one second list 4 and a user request requires at least one further data entry DE to be read from the data storage medium DISK and stored in the at least one second list 4 then accordingly at least one data entry DE stored in the at least one second list 4 needs to be replaced with the at least one further data entry DE. Preferably, those data entries which are positioned at the greatest distance from the current position POS in the data storage medium content directory 1 are then replaced first. This ensures that, by way of example, the current position POS can be moved forward or backward quickly and this is not delayed by other necessary access operations to the data storage medium DISK. However, it may also be necessary to replace data entries DE in the at least one second list 4 if a directory DIR has been selected and as a result has become the current directory 2. The content of the current directory 2 may then replace the data entries DE in the at least one second list 4 which are associated with the previously valid current directory 2.

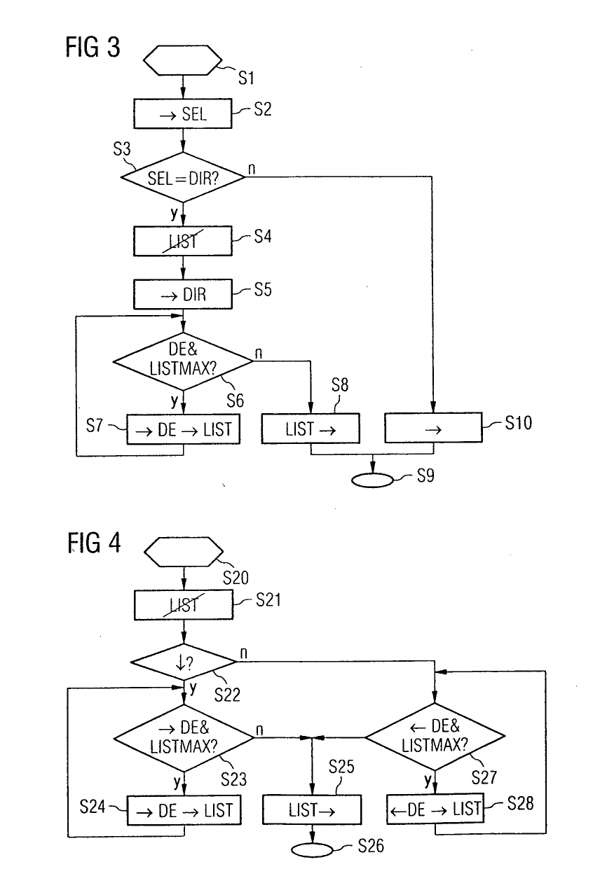

FIG. 3 shows a first flowchart for a program for changing the current directory 2 which is executed by the processor CPU, for example. The program starts in a step S1. Step S1 is preferably executed as a result of a selection SEL of a data entry DE by the user.

In a step S2, the user's selection SEL is detected. In a step S3, a check is performed to determine whether the selection SEL is a data entry DE which represents a directory DIR. If this condition is met, the at least one second list 4 of data entries DE is erased in a step S4. However, the at least one second list 4 of data entries DE may also be erased, by way of example, by virtue of any data entries DE present in the at least one second list 4 being declared invalid.

In a step S5, the selected directory DIR becomes the current directory 2. In a step S6, a check is performed to determine whether at least one further data entry DE in the current directory 2 of the data storage medium content directory 1 needs to be read. In addition, a check is performed to determine whether the at least one second list 4 can still store at least one further data entry DE, i.e. whether the second maximum number of entries has not yet been reached. If at least one further data entry DE can be read and can be stored in the at least one second list 4, the further data entry DE in the data storage medium content directory 1 is then read from the data storage medium DISK in a step S7 and is stored in the at least one second list 4. The program is then continued in step S6.

Step S7 is thus repeated until no further data entries DE in the current directory 2 can be read or until the second maximum number of data entries DE have been stored in the at least one second list 4. The program is then continued in step S8. In step S8, the at least one first list 3 is updated and is displayed on the display unit. The program ends in a step S9.

If the selection SEL in step S3 is a data entry DE which represents a file FILE then the program is continued in a step S10. In step S10, a file content in the file FILE can be reproduced, for example.

FIG. 4 shows a second flowchart for a second program which is likewise preferably executed by means of the processor CPU. The program starts in a step S20. Step S20 is executed, by way of example, when the user moves the current position POS in the data storage medium content directory 1 forward or backward. By way of example, the current position POS is moved forward or backward in steps of one respective data entry DE, but may likewise be moved forward or backward in steps of more than one data entry DE in each case, e.g. in a step skipping the first maximum number of data entries DE.

If the current position POS is moved forward or backward in a step skipping the first maximum number of data entries DE, for example, then in a step S21 the at least one second list 4 is erased or declared invalid. In a step S22, a check is then performed to determine whether the current position POS in the data storage medium content directory 1 has been moved forward or backward. If the current position POS has been moved forward (Y) then in a step S23 a check is performed to determine whether the data storage medium content directory 1 contains at least one further data entry DE in the current directory 2 which follows the last data entry DE among the data entries DE stored in the at least one second list 4. In addition, a check is performed to determine whether the at least one second list 4 can still store at least one further data entry DE, i.e. whether the second maximum number of entries has not yet been stored in the second list. If these conditions are met then in a step S24 the at least one further data entry DE is read from the data storage medium DISK and is stored in the at least one second list 4. The program is then continued in step S23. Step S24 is therefore repeated until no further data entry DE can be read in the current directory 2 or until the second maximum number of data entries DE has been stored in the at least one second list 4. The program is then continued in a step S25. In step S25, the first list 3 of data entries DE is then updated and is displayed on the display unit. The program ends in a step S26.

If it is established in step S22 that the user has moved the current position POS backward then in a step S27 a check is performed to determine whether the data storage medium content directory 1 contains at least one further data entry DE in the current directory 2 which is arranged before the first data entry DE in the at least one second list 4. In addition, a check is performed to determine whether the at least one second list 4 can still store at least one further data entry DE, i.e. whether the second maximum number of entries has not yet been reached in the second list. If these conditions are met then at step S28 the at least one further data entry DE is read from the data storage medium DISK and is stored in the at least one second list 4. The program is then continued in step S27. Step S28 is therefore repeated until no further data entry DE can be read in the current directory 2 or until the second maximum number of data entries DE has been stored in the at least one second list 4. The program is then continued in step S25 and is terminated in step S26.

While requiring only a constant or limited memory space, the apparatus allows navigation through the data storage medium content directory 1 independently of the directory structure, the number of files FILE, directories DIR or directory paths PATH or possibly further data entries DE in the data storage medium content directory 1 and independently of a length of file names or directory names, since only the at least one first list 3 currently being displayed by means of the display unit needs to be stored in the memory RAM in the form of the at least one second list 4. However, the at least one second list 4 may additionally store further data entries DE, particularly ones which adjoin the at least one first list 3, if the second maximum number of data entries DE is greater than the first maximum number of data entries DE in order to be able to speed up navigation in this way.

The apparatus may also be designed to display file names or directory names on the display unit which are too long to be able to be shown completely, when navigating through the data storage medium content directory 1. Preferably, only as many characters of the respective file name or directory name are read from the data storage medium DISK containing the associated data entry DE as can be shown at the same time on the display unit using the at least one first list 3. Upon user request, it may then be possible to read further characters of the respective file name or directory name from the data storage medium DISK and display them. Just like data entries DE in the at least one second list 4, the further characters may replace those characters of the file name or directory name, which have previously been stored with the respective data entry DE and are currently not being displayed. This means that the memory space required for file names or directory names is constant or does not exceed an upper limit. However, the file names or directory names are fully available, regardless of the length of the file names or directory names, as a result of further characters being read from the data storage medium DISK after the user request. It is also possible to store more characters of the file name or of the directory name for each data entry DE than can be displayed at the same time for each data entry DE on the display unit. This makes it possible to speed up the display action of long file names or directory names, since fewer access operations to the data storage medium DISK are required in order to read the further characters.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for displaying a data storage medium content directory of a data storage medium, which comprises:
an input device for receiving a user request defining a current position in said data storage medium content directory;
a display unit of limited size for displaying a first list comprising a first maximum number of successive data entries in said data storage medium content directory, wherein said data entries in said first list are based on said current position in said data storage medium content directory;
a memory storing at least one second list comprising a second maximum number of data entries, said second maximum number of data entries being at least as great as said first maximum number of data entries and comprising all said data entries of said first list, said data entries in said at least one second list being used for updating said first list to be displayed on said display unit;
means for reading at least one further data entry in said data storage medium content directory from said data storage medium based on said current position and for storing said further data entry in said at least one second list if said further data entry is currently not stored in said at least one second list; and
means for replacing at least one of said data entries stored in said at least one second list with said at least one further entry on the basis of said current position if said at least one second list already comprises said second maximum number of data entries.

2. The apparatus of claim 1, wherein the user request received by said input device defines said current position as a selected data entry which represents a directory or a directory path, or defines said current position by a stepwise forward or backward movement from a previous current position in said data storage medium content directory in steps of at least one of said data entries.

3. The apparatus of claim 1, wherein said memory stores at least two second lists of data entries in said data storage medium content directory, and the apparatus further comprises means for associating said at least one further data entry with one of said at least two second lists on the basis of a data entry type of said at least one further data entry.
